(19) United States
(12) Patent Application Publication
(10) Pub. No.: US 2025/0139664 A1
(43) Pub. Date: May 1, 2025

(54) METHOD FOR MANAGING DATA RELATING TO AN OFF-THE-SHELF ITEM

(71) Applicant: MAISON NEYRET, SAINT-ETIENNE (FR)

(72) Inventors: Benoit NEYRET, SAINT-ETIENNE (FR); Sylvain RIVOIRE, SAINT-ETIENNE (FR)

(21) Appl. No.: 19/002,534

(22) Filed: Dec. 26, 2024

(30) Foreign Application Priority Data
Jul. 5, 2022 (FR) 2206847

(51) Int. Cl. G06Q 30/0251; G06K 7/14

(52) U.S. Cl. CPC G06Q 30/0257; G06K 7/1417

(57) ABSTRACT

A method is provided for data management related to a ready-to-wear item or accessory in the fields of fashion, textile, and clothing, the data being accessible via a label on the item, preferably a woven label, and presenting an identifier such as a 2D code or a QR code, and the label being affiliated with this item. The data is stored on a server and modifiable via an online platform executed on the server. The method includes assigning each identifier in the database to at least one category in the database and simultaneously modifying the data related to multiple items by modifying data related to a category of these items.

### TECHNICAL FIELD

The invention relates to the technical field of ready-to-wear and accessories in the domains of fashion, textile, and clothing.

### PRIOR ART

In the field of fashion and accessories, brands wish to communicate with the consumers of their products, that is, their customers. For this purpose, several solutions are known. It is possible to send emails to customers identified within a brand's database, for example, based on the loyalty accounts of these customers with the brand. It is also possible to send push notifications to customers who have installed an application distributed by the brand on their smartphone.

The disadvantage of these solutions is that the communications are pushed by the brand, and not requested by the customer. The latter may therefore have a resentment against such communications, which are unsolicited.

Moreover, these communications are generally decoupled from the items that the customer actually owns. The communication is too general and does not correctly target the customers to be informed.

Finally, these solutions are not compatible with the second-hand market, because if the first customer can be known to the brand, it does not know if and when the initially acquired item has been resold. The second customer, that is, the new purchaser, cannot be contacted by the brand. The brand thus misses part of its communication target.

Furthermore, there are labels presenting codes, such as barcodes or 2D codes like QR codes. Such codes can encode data such as text, to present information to the customer when they scan the code with a smartphone. These codes can encode an address of a website (i.e., “URL”, according to the acronym of the English Uniform Resource Locator). These labels are attached to the item and are therefore likely to follow the item throughout its life, which allows reaching a second customer. The disadvantage of such labels is that the code is no longer modifiable once the label is manufactured. The brand can no longer easily modify the content of its communication once the label is manufactured.

Additionally, there is a difficulty in the affiliation of a label presenting a code with the corresponding item. Indeed, a code is generally not meaningful, so its reading with the naked eye does not allow knowing what information is encoded by this code. This fact is exacerbated when it is a barcode or a 2D code.

In this case, it can be complicated for a fashion contractor with labels intended for different items to know which label should be sewn onto which item. Two labels may present the same brand logo, each with a different 2D code, the first corresponding, for example, to a t-shirt and the second to a sweater. These two labels cannot be differentiated with the naked eye. There is therefore a risk of not attaching the correct label to the correct item.

Next, the prior affiliation of a label with a 2D code to a particular item imposes, both on the manufacturer of the labels, the brand that purchases the labels, and the fashion contractor who manufactures the items and attaches the labels to the items, a rigorous tracking of the stock of each label reference, based on their affiliation: labels that appear similar but present a different code must not be interchanged.

The individual affiliation of each label to the corresponding item is tedious.

Moreover, there is a risk of counterfeiting by the fashion contractor: having the raw materials validated by the brand, and the brand's labels (“textile tags”), the fashion contractor can manufacture surplus items without the brand's agreement and sell them on their own initiative on secondary markets. This is a “grey market,” as opposed to a “black market,” because these are genuine items and not imitations, but marketed without the brand's control or authorization.

Documents KR101075897B1, US20170132892A1, and US20190114584A1 describe data management methods, but they do not provide complete satisfaction:
KR101075897B1 concerns the modification of data accessible on a website, from a QR code. This document does not provide teachings regarding the management of a brand's database, which includes a multitude of entries corresponding to the different items offered by this brand.
US20170132892A1 concerns a data management method for the manufacture of labels and does not provide teachings regarding the evolution of the content of a communication related to an item once the label is manufactured.
US20190114584A1 concerns a data management method for logistical applications and is neither adapted to the management of a brand's item database nor to the communication constraints towards customers in the fields of fashion, textile, and clothing.

### SUMMARY OF THE INVENTION

One of the objectives of the invention is to overcome the disadvantages of the prior art.

In particular, it may involve offering a brand a communication medium that is scalable, so that the content of the communication can be updated based on the evolution of the data to be provided.

It may also involve facilitating the affiliation of woven labels presenting a code with a corresponding item.

To this end, a method for data management related to a ready-to-wear item or accessory in the fields of fashion, textile, and clothing has been developed, with the data being accessible via a label on the item, preferably a woven label, and presenting an identifier such as a 2D code or a QR code, and the label being affiliated with this item, meaning that this QR code is linked to this item within the database, and scanning the 2D code, for example with a smartphone, allows access to and/or display of the data on a smartphone application or on a web browser;
the data being stored on a server and modifiable via an online platform executed on the server.

The method according to the invention consists of:
assigning each identifier in the database to at least one category in the database;
simultaneously modifying the data related to multiple items by modifying data related to a category of these items.

In this way, the communication is requested by the customer when they scan the 2D code, rather than being pushed by the brand. The customer no longer feels intruded upon.

Next, the label, preferably woven, is durable and has a lifespan equivalent to that of the item. The code is therefore accessible to potential second-hand purchasers of the item, who can benefit from the brand's communications even without being identified by the brand through a loyalty program. The invention also facilitates the compliance of the brand's communication methods with the requirements related to the protection of customers' personal data, such as the EU Regulation 2016/679 (General Data Protection Regulation, “GDPR”), as the brand can communicate with its customers without needing their personal data.

A printed label is less expensive but less durable than a woven label. A woven label is more complex and more expensive than a printed label, but its durability is significantly superior. The printing on a printed label may withstand at most a few dozen washes, whereas a woven label has a lifespan at least equal to that of the item.

Finally, since the data can be modified, it is possible to change the content of the brand's communication independently of the manufacturing of the labels bearing the code. The communication intended for the customer can therefore be scalable.

The identifier can be an alphanumeric sequence, or a code such as a barcode or a two-dimensional code (“2D code”). Preferably, it is a QR code:
encoding the identifier, so that scanning the QR code with a reader allows the label to be identified, or;
encoding a source URL comprising an alphanumeric sequence corresponding to the identifier of the label. In this case, the source URL allows the label to be identified and/or directs a web browser to a web page corresponding to the scanned label.

In the rest of this document, reference is generally made to the “code” carried by the label, without excluding modes where the label only carries an identifier.

By “affiliation,” it is meant the linking, within a database, of the identifier of the label to the item that receives the label. In practice, the affiliation corresponds to the association, within the database, between the identifier of the label and a key of the database, allowing the item to be identified within the item database. The key can be, for example:
a code commonly used in the considered field, such as the stock-keeping unit of an item, its universal product code, or its European article number (respectively “SKU,” “UPC,” and “EAN”),
an address of a website (“URL”).

Depending on the desired resolution for data administration:
the identifier of the label is unique. In this case, all manufactured labels can be interchanged by the fashion contractor, but the burden of verifying the uniqueness of each produced label falls on the label manufacturer.
the identifier of the label is not unique. In this case, the manufacturing of the labels is facilitated, but the fashion contractor must be careful not to interchange labels from different series (bearing different identifiers).
the key designates a model of an item (for example, a model of a bag). This solution is preferred for mass distribution, which does not require the ability to differentiate an item from another item of the same model after acquisition by a customer.
the key designates a unique item (and not all items of the same model of bag, for example). This solution is preferred for traceability or anti-counterfeiting applications, as it allows the differentiation of an item from another item of the same model after acquisition by a customer.

Even if the affiliation takes place after the provision of the label, it can occur before or after the label is affixed to the item.

By “data related to an item,” it is meant any type of informative content, textual, multimedia, or target URLs of a web page. The invention particularly concerns data that pertains to a purchaser of the item (the customer user of the item). This may include, for example, authenticity or traceability data, certification of the item according to a quality or environmental standard, information on the place of manufacture.

By “online platform,” it is meant any utility executed on the server, such as a web page whose graphical interface allows the selection of the item whose data needs to be modified, and the entry of a new value for the modification. It can also be a utility without a graphical interface, such as a program executing a computer query to modify certain data within the database.

The data is updated “simultaneously” as opposed to “individually,” meaning that the modification of the data is ordered for all the concerned items at the same time. Normal execution delays of programs or queries on the server are not taken into account, nor the fact that the data is practically modified one after the other, since it is the database management that is being considered.

A category is a grouping of identifiers. This can be a collection in the sense of the ready-to-wear domain (“spring-summer 2022 collection”), a family of items (“pants”), a market segment (“ecological materials”), etc. An item belongs to one or more categories. In practice, an item is assigned to a category by entering the same value in a field of the database for multiple items. A category is thus defined positively during the administration of the brand's database.

Thus, the invention allows a brand to communicate with its customers in a targeted rather than generic manner, in an evolving way, and throughout the item's lifespan.

According to a particular embodiment, the platform collects and records usage data of the identifiers and/or usage data of the data related to the item. This data is then segregated and compiled so that the brand can perform data analysis, for example, on the usage of the items or the lifecycle of the items.

Preferably, and to ensure traceability and the finest possible data analysis, the identifier is unique.

To facilitate the bulk modification of data, it is carried out by integrating a synchronization file of an electronic data interchange, known as “EDI,” which means the communication of digital documents in a standardized format, allowing the automatic transfer of data between two entities, from machine to machine. In practice, a first computer application issues an EDI file, containing the data, to a second computer application. The exchange can be done by sending standardized messages, or by combining a file deposit in a directory initiated by the first entity, and a watcher of this directory implemented by the second entity.

The EDI file includes a list of the identifiers of the database rows to be modified, the fields concerned by the modification, and the new values.

To trigger the modification, for example, by the manufacturing of the labels, the EDI file is issued by an enterprise resource planning (ERP) software of the label manufacturer. In this case, the modifications made by the label manufacturer are intended for the brand, and these modifications can serve as a production tracking indicator.

Additionally or alternatively, to ensure that the implementation of the modification does not require the brand to use an additional computer tool, the EDI file is issued by an ERP software of the brand, that is, the purchaser of the labels.

Additionally or alternatively, the modification is triggered by the affiliation of the labels of a category to the corresponding items. This allows, for example, updating data intended for the brand, such as logistical data or production tracking data, depending on how the affiliation is organized. In this case, the modification is carried out by a computer program implemented to perform the affiliation. It is preferably carried out when the labels are affiliated in batches.

To manage the end of life of the items, and subsequently to be able to purge the database of superfluous data, assigning the identifier to a category called “end of life” prevents the modification of content data.

The identifiers are preferably generated by a cryptographic algorithm based on a timestamp, that is, from a duration elapsed between a fixed event and the moment of the identifier's generation. This ensures their uniqueness without the need to verify against the existing identifiers in the database.

To facilitate the reading of the identifiers and avoid dyslexia, the algorithm provides pseudo-random alphanumeric sequences intended to constitute a part of the identifier. By “pseudo-random,” it is meant an alphanumeric sequence that appears to be a random sequence:
labels belonging to the same manufacturing batch do not present a sequence that is incremented from one label to another (for example, the sequence does not go from “0001” to “0002” then “0003,” but from “L8OY” to “2R8L” then “W82W”);
the alphanumeric sequence is nevertheless provided in a determined manner by the algorithm and is therefore not random.

In a particular embodiment, the data related to the item contains a target URL. In this case, the brand can, for example, generate a new web page each time it wishes to modify its communication. The modification of the data mainly consists of replacing the URL of the page of the old communication with the URL of the page of the new communication.

In another mode, the data related to the item contains a source URL. To categorize them easily, several source URLs include a common root, that is, a part of the path and/or domain name that is common. This also facilitates the transfer of data management, as the transfer then involves the domain name defined by the common root.

To facilitate and speed up the selection of multiple labels whose data needs to be modified, the selection is made by entering a grouping identifier of a predefined grouping category. In practice, the grouping category corresponds to the packaging of a handling unit of labels, all affiliated with the same type of items.

Preferably, the entry of the grouping identifier is done by scanning a grouping 2D code. This eliminates any risk of typing errors. This grouping 2D code can appear on a packing list of the labels, for example, during the delivery of the labels to the fashion contractor.

To avoid any risk of interchange between multiple grouping 2D codes, the entry of the grouping identifier is done by scanning a grouping 2D code present on the packaging of a handling unit of the labels.

A method has also been developed for the affiliation of a label, preferably woven, to an item of the ready-to-wear and accessory type in the fields of fashion, textile, and clothing; the label being attached to the item and presenting an identifier such as a 2D code or a QR code encoding the identifier within a database.

According to the invention, the label is affiliated after its provision to the purchaser of the label or to a fashion contractor.

In this way, the labels are affiliated at the latest possible stage, which facilitates the management of their stock. It is possible to manufacture the labels in large quantities and store them without needing to differentiate the different batches based on the identifier of each label. In particular, this allows for a reduction in label stocks as they are universal until they are affiliated. It is only after their delivery to the brand or the fashion contractor that the differentiation will be made, and each label will be associated with an item.

To accelerate the affiliation, multiple labels are affiliated simultaneously.

To facilitate the entry of the labels to be affiliated, they are selected by entering a predefined grouping identifier.

Still with this aim, the entry of the grouping identifier is done by scanning a grouping QR code.

To limit the risk of error between multiple grouping identifiers, scanning a grouping QR code present on a packaging of grouped labels allows the entry of the grouping identifier.

To ensure that only labels whose code reading has not been degraded during the manufacturing of the item or during the attachment of the label are affiliated, the label is affiliated with the item after it has been attached to the item. In this case, the affiliation can serve as production tracking data.

To limit the risks of counterfeiting, the label is affiliated with the item at the time of its sale in the store. Thus, only items marketed in a manner controlled by the brand carry an affiliated, and therefore functional, label.

To facilitate data entry during the affiliation, it is carried out using an application executed on a smartphone, by identifying the model of the item to be affiliated within the application, and by capturing a 2D code encoding the identifier, carried by an item corresponding to the identification made. The order of execution of these two actions is indifferent.

Still with this aim, and to accelerate the affiliation, the affiliations of multiple items are carried out using an application executed on a smartphone, by identifying the model of the item to be affiliated within the application, then by successively capturing 2D codes encoding the identifier, carried by items corresponding to the identification made. In practice, the type of item to be affiliated is selected (for example, a particular model of handbag), then the labels of all the bags of this model that need to be affiliated are scanned successively.

In another mode, the affiliation is carried out by integrating a synchronization file of an electronic data interchange, known as “EDI.” In this way, the affiliation is automatic and does not require any other manipulation by the manufacturer, the brand, or the fashion contractor.

In a first case, the synchronization file is issued by an enterprise resource planning (ERP) software of a purchaser of the woven labels, that is, the brand. This case is suitable when the server on which the database is recorded is hosted by a person other than the brand, for example, the label manufacturer. This also allows the brand to control the affiliation of the labels, thus limiting the grey market because only the labels that the brand has chosen to affiliate are functional.

In a second case, the synchronization file is issued by an enterprise resource planning software of the manufacturer of the woven labels. This case is suitable when the server on which the database is recorded is hosted by a person other than the label manufacturer, for example, the brand. This also allows more flexibility in the management of the manufacturing and storage of the labels, as only the functional labels, excluding production defects, are affiliated.

The invention also concerns an installation comprising a server including a database and executing a computer program and/or an online platform, configured to implement a method according to the aforementioned characteristics.

### BRIEF DESCRIPTION OF THE DRAWINGS

FIG. 1 is a diagram illustrating the material and immaterial exchanges between a brand, a label manufacturer, a fashion contractor, and a customer of the brand.

FIG. 2 illustrates a ready-to-wear item equipped with a label comprising a 2D code.

FIG. 3 illustrates a graphical interface of a smartphone application presenting data related to a ready-to-wear item such as a t-shirt.

FIG. 4 illustrates a database comprising identifiers of labels, categories, source URLs, and target URLs.

FIG. 5 illustrates a database comprising identifiers of labels, categories, and data related to ready-to-wear items such as lingerie items.

FIG. 6 illustrates a graphical interface of an online platform allowing the modification of data of items in a category.

### DETAILED DESCRIPTION OF THE INVENTION

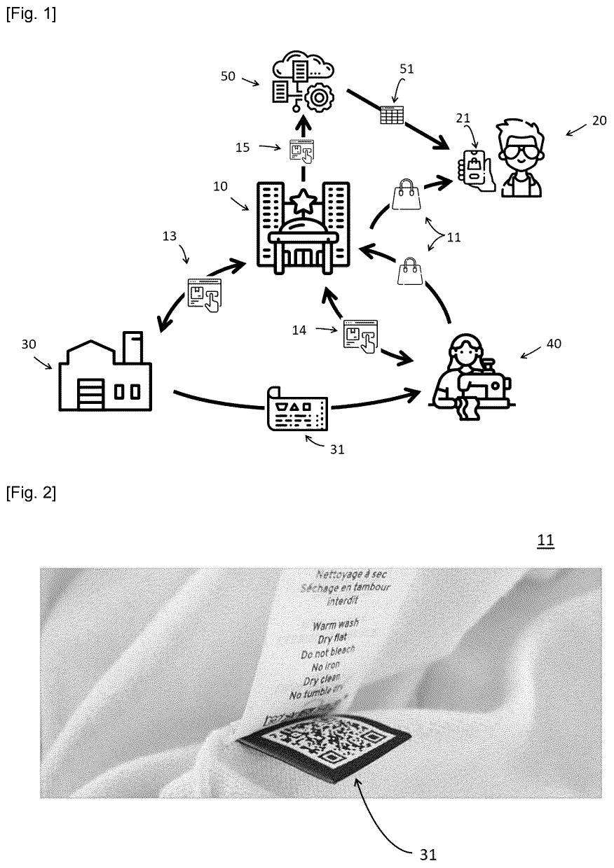

With reference to FIGS. 1 to 3, the invention relates to data management enabling a brand (10) to connect with its customers (20) through labels (31) attached to the items (11) it sells.

With reference to FIG. 2, these labels (31) present a code, preferably a 2D code such as a QR code. The code is scanned by a customer (20), or flashed, for example, using a smartphone (21).

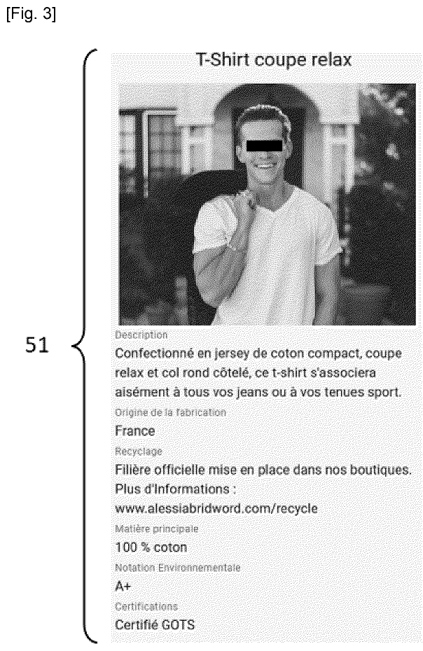

With reference to FIG. 3, the customer (20) then accesses data (51) related to the item (11). The data (51) can be:
information related to the item (11) itself, such as the composition of the item (11), its place of manufacture, care instructions;
information related to the item (11) from the brand's (10) perspective, such as suggestions for other complementary items or items from the same collection that may interest the customer (20): it could be a shirt matching the pants the customer (20) just scanned.

Since the label (31) is no longer modifiable after its manufacture, the method according to the invention allows for easy modification of the data (51) after the label (31) has been manufactured. In particular, the data (51) can be modified while the item (11) is already in circulation (in store) or already sold to a user.

As the label (31) is generally manufactured by a different company than the fashion contractor (40), it is necessary to affiliate each label (31) with the corresponding item (11) within the database. To manage the manufacturing of the labels (31) in a non-differentiated manner, the affiliation is carried out after its provision by the label manufacturer (30). This is valid:
whether the labels are delivered to the brand (10) which will then transmit them to its fashion contractors (40), or
whether the labels (31) are delivered directly to a fashion contractor (40).

Thus, all labels (31) are similar during their manufacture, in that they are interchangeable (except that they present different respective identifiers). It is only when a label (31) is affiliated with a particular item (11) that the label (31) is no longer interchangeable.

The delayed differentiation according to the invention allows for easy production management as well as stock management.

To make the affiliation faster, multiple labels (31) are affiliated simultaneously with their items (11). For this, several methods are considered.

In a preferred embodiment, the affiliation is carried out by the fashion contractor (40), prior to the attachment of the labels (31) to the items (11), using a grouping label that is placed on a packaging of grouped labels (21). For this, the manufacturer (30) has previously defined the grouping category as including the labels (21) that it has placed in the grouping packaging.

The grouping label presents a code encoding the identifier of a grouping category. Thus, the entry or scan of this code allows a computer program to select all the labels (21) of this grouping category, using their identifiers.

The fashion contractor (40) indicates through the computer program which type of item (11) they want to affiliate the labels (21) with, and enters the identifier of the grouping category. The computer program then affiliates each label (21) of the category with this type of item.

In practice, the fashion contractor (40) prepares the manufacturing of the items (11) by selecting all the necessary components, including the labels (31) delivered in their grouping packaging. They perform the affiliation using the grouping label, then start the manufacturing of the items (11).

This method is efficient because a large number of labels (31) are affiliated simultaneously, for example between 100 and 500 labels (31).

In other modes, the affiliation is carried out after the attachment of the labels (31) to the items (11).

A first method consists of identifying the type of item to be affiliated, using an application executed on a smartphone. Then, the fashion contractor (40) successively scans all the corresponding items (11). At each iteration, the scanned label (31) is affiliated with the selected item (11). The affiliation of all the scanned labels (31) can also be done simultaneously, after all the scans, triggered by a graphical interface component within the application.

This first method can also be performed by an employee of the brand (10). It is also possible to scan all the labels (31) of the items (11) to be affiliated, and then select the type of item within the application. In this case, the affiliation of all the labels (31) is done simultaneously.

A second method consists of using an EDI method to affiliate the labels (31) to the items (11) on which they are to be affixed, or on which they are already affixed. In this case, the EDI file is preferably issued by the brand (10). Such an EDI exchange is symbolized by exchange (14) in FIG. 1. The brand (10) then informs the fashion contractor (40) which labels (31) to use during the manufacturing of the items (11), based on their identifiers.

This method provides more control to the brand (10), which knows in advance which label (31) will be affixed to which item (11), and prevents items (21) from being put on the market without its authorization for their affiliation.

By the subsequent modification of the data (51) by the fashion contractor (40), this method can also serve as a logistical tool or for production tracking.

Alternatively, a third method consists of affiliating the labels (31) by EDI during the manufacturing of the labels (31), in which case exchange (13) is implemented.

In this case, the manufacturer (30) must produce the exact number of labels (31) according to the needs of the brand (10). The labels (31) are delivered to the fashion contractor (40) already affiliated with an item (11), even before its manufacturing: the fashion contractor (40) must therefore be careful not to mix up the labels (31), at the risk of not respecting the prior affiliation.

A fourth method consists of individually affiliating the label (31) to its item (11), without using a grouping category. In this case, the application is executed on a smartphone (21), the user identifies the model of the item, and enters the identifier of the label (31) or scans its code with the smartphone.

This method is more tedious because the affiliations are performed individually. Nevertheless, this fourth method is advantageously implemented during the sale of the item (11) in a store authorized by the brand (10): thus, the risk of a grey market is completely eliminated.

The third and fourth methods allow the brand to have more control over the affiliation of the labels (31).

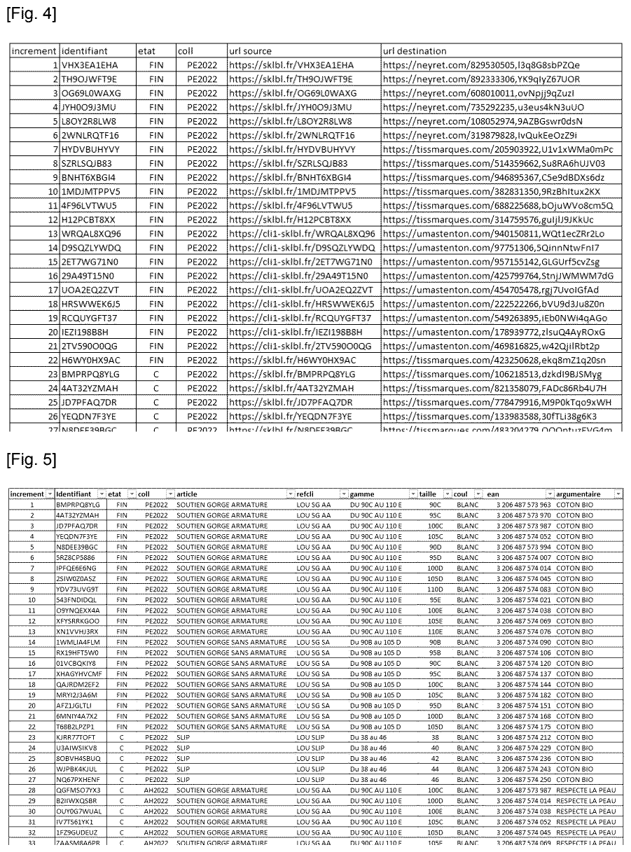

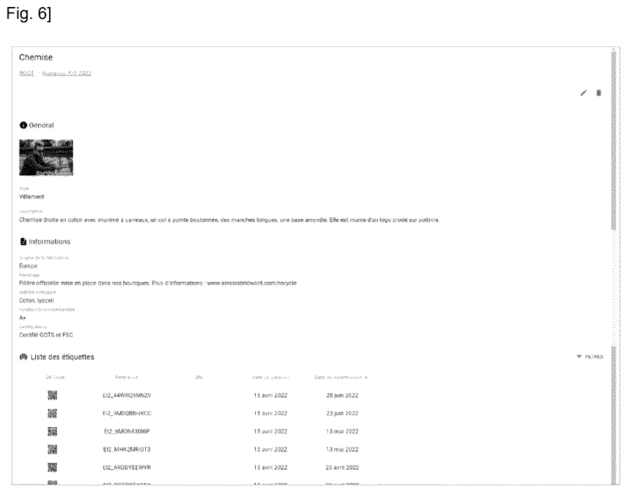

With reference to FIGS. 4 and 5, the data (51) is stored within a database on a server (50). This database includes identifiers of the labels (31), and the labels (31) are grouped into categories. Alternatively, the items (11) are grouped into categories, according to the key used in the database.

The database includes two types of data:
non-modifiable data, such as the UID, SKU, model, or color of the item;
modifiable data, such as traceability information (chain of possession), brand-related information, a redirection URL, and one or more categories.

Each label (31) is assigned to at least one category. In the given examples, each label is assigned to two categories:
based on its status (“End” status for “end of life,” or “C” status for “in circulation”); and
based on its collection (“SS2022” for the “spring-summer 2022” collection or “FW2022” for the “fall-winter 2022” collection).

These categories allow for the quick selection of all items (11) that are part of a category, in order to make bulk modifications to these items (11). For example, items (11) from an obsolete collection can all be simultaneously changed from the “in circulation” status to the “end of life” status. Items (11) are preferably assigned to at least two categories.

In this case, assigning the identifier to a category called “end of life” prevents the modification of other content data. This allows the brand (10) to manage which items (11) are still active on the market or not, and it allows the server (50) administrator to delete obsolete rows from the database when they detect that items (11) have been in the “end of life” category for a duration exceeding a given threshold.

FIG. 4 illustrates a case where the data (51) is accessible via a web browser. In this case, the codes of the labels (31) encode source URLs. To make the modification of the data (51) easy, each source URL corresponds to a target URL, and updating the database consists of modifying the target URLs of the items (11) in the concerned category.

In particular, rows 13 to 21 of the database include source URLs with a common root (“cli1-”), for example, to identify all the source URLs of a customer. In this way, the transfer of the source URLs of this customer is easy, as it is sufficient to transfer the management of the domain name “https://cli1-sklbl.fr/” to them so that they obtain the management of all their source URLs.

FIG. 5 illustrates a case where the data (51) is accessible via a dedicated application. In this case, the codes of the labels (31) encode the affiliation identifier of the item (11). The modification of the data (51) consists of modifying only the concerned field(s) within the database. For example, it is possible to modify only the country of origin of an item if the brand (10) decides to change the fashion contractor (40), even though the labels (31) are already manufactured.

The categories can also be based on serial numbers, so that the same type of item (11) corresponds to multiple categories, each defined by a manufacturing batch of the item (11). In this case, an item (11) is linked to multiple categories:
the type of item in question (e.g., t-shirt);
the collection (e.g., SS2022);
the serial number.

For each item (11) of a given type and collection, it is therefore possible to inform the customer (20) of the country of origin, or the particular fashion contractor (40) who manufactured the item (11).

In the case where the data related to multiple items (11) evolves, for example, if a new method of collecting end-of-life items (11) is proposed, it is possible to indicate this new method for all the concerned items (11) by the appropriate selection of categories. This could involve, for example, selecting all items made from 100% cotton fabrics.

Furthermore, if a legislator requires the brand (10) to communicate additional information, such as an assessment of the environmental impact of the manufacturing of the item (11), then this field can be added to the data (51) without difficulty, as the labels (31) are already manufactured, and the items (11) may already be sold.

With reference to FIG. 6, the selection of the category corresponding to all these items (11) is carried out using an online platform. The modification of the data (51) can consist of modifying the values of certain fields, and/or adding additional fields within the database. In the above example, a new field “end-of-life instructions” will now be accessible for the concerned items (11).

When the customer (20) scans the code of the label (31) of their item, they will have access to the new information, which states that a new collection method is now available.

The method and installation according to the invention thus allow for the administration of the server's (50) database in an evolving and dynamic manner, while the codes present on the labels (31) are fixed and no longer modifiable.

The ability to modify the data (51) simultaneously for multiple items (11) allows for easy administration of the database. In practice, the bulk modification of the data (51) of multiple items (11) can be carried out in different ways.

First of all, the modification of the data (51) can be carried out by EDI. For example, if the cotton/elastane ratio of a raw material is not constant, the fashion contractor (40) can declare the composition used by EDI, meaning that the fashion contractor (40) will issue standardized electronic messages that will be transmitted to the brand's (10) computers (or its IT service manager) which will be able to interpret and automatically integrate the corresponding data into their respective information systems without paper or human intervention. This process eliminates paper documents sent by mail or fax and manual entries by operators.

The EDI file can be issued by the brand (10), for example, when it wishes to add new fields to the database: it then issues an EDI file to the server (50) host.

The EDI file can be issued by the manufacturer of the woven labels.

The EDI file can be issued by the fashion contractor (40), for example, in the situation mentioned above, where the composition of the item (11) needs to be modified within the data (51).

In all cases, the EDI file is preferably issued by an enterprise resource planning (ERP) software.

Additionally or alternatively, the modification of the data (51) can be carried out using a computer program or a smartphone application, similarly to the methods previously described for performing affiliations:
the selection of multiple labels (31) to be modified can be done by entering an identifier of a grouping category of these labels (31);
preferably, this entry is done by scanning a code encoding this identifier, such as a 2D code or a QR code;
this code is advantageously placed on the packaging of the grouped labels (31) to be selected, for example, during their delivery to the fashion contractor (40).

All these modes are also applicable to the delivery of the items (11) to the brand (10), after manufacturing by the fashion contractor (40). In this case, it is the fashion contractor (40) who must create the grouping category.

To provide the brand (10) with information about the usage and lifecycle of its items (11), and advantageously information related to its customers (20), the platform collects and records usage data of the scanned source URLs (or identifiers), and/or usage data of the data related to the item.

The platform can then offer statistics for market analysis or customer relationship management (“CRM” according to the English translation “customer relationship management”). The statistics can include geolocation, the gender of the customer (20), their age, etc.

The installation for implementing the method of the invention therefore includes:
multiple labels (31) intended to be affiliated with items (11);
at least one server (50) storing a database (51), which data (51) includes an identifier of each label (31), and several fields corresponding to at least one category of identifier, and at least one data such as a target URL;
at least one computer executing a computer program allowing a customer (20) to view information related to the item (11), before, during, or after the act of purchase. Preferably, it is a smartphone running an application.

At least one supplier of a brand (10) is involved, and generally two suppliers: a manufacturer (30) of the labels (31) and a fashion contractor (40) manufacturing the items (21) and attaching the labels (31) to them.

The server (50) runs an online platform, preferably with a graphical interface such as a website, so that the brand (10) can modify the data (51) of the label (31) of an item (11) whenever it wishes via the update (15), and advantageously after the sale of the item (11) to a customer (20).

In the case where data modifications are only done by EDI, then the online platform is a computer program that does not necessarily require a graphical interface.

In all cases, the terms “smartphone application” and “computer program” are to be interpreted in a broad sense. There may be different applications, intended to be used either by the brand (10), the customer (20), the manufacturer (30), or the fashion contractor (40).

In this way, the reading of the labels (31) is contextualized, and each application is programmed for uses adapted to each user (10, 20, 30, 40).

For example, when scanning a label (31):
the brand's (10) application will be programmed to affiliate this label (31) with an item (11), or to modify the data (51) of the affiliated item (11);
the user's (20) application will be programmed to display the data (51) of the item (11);
the manufacturer's (30) application will be programmed to verify the readability of the label (31);
the fashion contractor's (40) application will be programmed to individually affiliate the label (31) with an item, or to affiliate labels (31) in batches in the case of successive readings.

It can also be a single application, for which different user profiles are provided, depending on their identifiers and access codes.

Furthermore, the method and installation can be configured differently from the given examples without departing from the scope of the invention, which is defined by the claims.

In particular, the affiliation and modification of data can be carried out simultaneously, especially in the case of implementation by EDI. The EDI can be implemented at different stages of the method, so that within the method, EDI files can be issued by the brand (10), then by the manufacturer (30), and then by the fashion contractor (40).

In another embodiment, the modification is triggered by the affiliation of the labels (31) of a category to the corresponding items (11). In this case, the brand (10) has the data (51), and the affiliation is carried out by the fashion contractor (40). The affiliation serves as a triggering event to implement the modification, preferably by EDI.

Furthermore, the technical characteristics of the different embodiments and variants mentioned above can be combined with each other, in whole or in part. Thus, the method and installation can be adapted in terms of costs, functionalities, and performance.

1. A method for data management related to a ready-to-wear item or accessory in the fields of fashion, textile, and clothing,
the data being accessible via a label on the item, preferably a woven label, and presenting an identifier such as a 2D code or a QR code, and the label being affiliated with this item;
the data being stored on a server and modifiable via an online platform executed on the server;
said method comprising the steps of:
assigning each identifier in the database to at least one category in the database; and
simultaneously modifying the data related to multiple items by modifying data related to a category of these items.

2. The method according to claim 1, wherein the platform collects and records usage data of the identifiers and/or usage data of the data related to the item.

3. The method according to claim 1, wherein the modification of the data is carried out by integrating a synchronization file of an electronic data interchange, known as “EDI” file.

4. The method according to claim 3, wherein the EDI file is issued by an enterprise resource planning (ERP) software of a purchaser of the labels.

5. The method according to claim 3, wherein the EDI file is issued by an enterprise resource planning (ERP) software of the manufacturer of the labels.

6. The method according to claim 1, wherein the modification is triggered by the affiliation of the labels of a category to the corresponding items.

7. The method according to claim 1, wherein assigning the identifier to a category called “end of life” prevents the modification of content data.

8. The method according to claim 1, wherein the identifier is unique.

9. The method according to claim 1, wherein the identifiers are generated by a cryptographic algorithm based on a timestamp.

10. The method according to claim 9, wherein the algorithm provides pseudo-random alphanumeric sequences intended to constitute a part of the identifier.

11. The method according to claim 1, wherein the data related to the item contains a target URL.

12. The method according to claim 1, wherein the data related to the item contains a source URL, and several source URLs include a common root.

13. The method according to claim 1, wherein the selection of multiple labels is carried out by entering a grouping identifier of a predefined grouping category.

14. The method according to claim 13, wherein the entry of the grouping category identifier is carried out by scanning a grouping QR code.

15. The method according to claim 14, wherein scanning a grouping QR code present on a packaging of grouped labels allows the entry of the grouping category identifier.

16. An installation comprising a server including a database and executing an online platform, configured to implement a method according to claim 1.
